(19) United States
(12) Patent Application Publication
(10) Pub. No.: US 2007/0028854 A1
(43) Pub. Date: Feb. 8, 2007

(54) Cabinet for pets

(76) Inventor: Shiuan Kuen Chern, Arcadia, CA (US)

Correspondence Address: Raymond Y. Chan, 108 N. Ynez Ave., #128, Monterey Park, CA, 91754, US

(21) Appl. No.: 11/197,021

(22) Filed: Aug. 3, 2005

(51) Int. Cl. A01K 13/00

(52) U.S. Cl. 119/753

(57) ABSTRACT

The present invention discloses a pet dressing cabinet including a cabinet body having an accessory compartment and a front opening communicating with the accessory compartment, wherein the dressing cabinet further includes two fencing doors pivotally mounted at the front opening to fold between a storage position and a dressing position. A dressing platform is horizontally and frontwardly extended from the dressing cabinet at a position below the front opening for substantially supporting the pet on the dressing platform. And two fencing stoppers provided at two sides of the front opening to retain the fencing doors at the dressing position so as to block the pet on the dressing platform from escaping.

### BACKGROUND OF THE PRESENT INVENTION

1. Field of Invention

The present invention relates to a cabinet for pets, and more particularly, relates to pet furniture used not only for enclosing facilitating stuffs serviceable to the pets, but also accommodating a dressing area so as to treat the pet in a convenient and user-friendly manner.

2. Description of Related Arts

Commonly, pets needed to be given fresh air, freedom, and exercise. On the other hand, the pets are supposed to be in user's control under certain circumstances. For example, the pets should be bathed regularly. Needless to say, bathing the pets is an important part of responsible pet ownership. A clean and nicely dressed pet is a happy pet to receive more love and attention. Moreover, regular baths might help prevent skin diseases, thus saving the money on veterinary bills. Moreover, a pet should be examined daily to determine if he or she is dirty, has bad odors, has sign of skin diseases, or has parasites such as fleas and ticks. Sometimes, the pets needed to be checked or exam the entire body to remove foreign bodies from his coat while checking for lumps, bumps and wounds.

However, the subsequent combing procedure after a bath and the body checking procedure would be a hassle to most pet owners. Some pets are too naughty to be restricting within a circumscribed area, and more importantly, they would be in wild uneasiness or reluctant to the body treatment in case of parasite killing or bumps healing. In most cases, the pet would like to escape from such treatments.

There are a variety of pet enclosures available on the market for fending off the pets in a predetermined area so as to ensure a pet treatment. When the pets were reluctant to be treated, they would retreat or hide deeper within the enclosure to escape a human access. On the other hand, even the pets could be limited within a restricted area by the user, it would be highly impossible for the user extend a spared hand to obtain facilitating stuffs accomplishing such treatments. Unfortunately, the grocery stores, retail stores, and pet stores do not supply consumers with enclosures or furniture concealing the necessary facilities or litter box from physical view. It is desirable to develop a pet furniture defining a dressing area thereon for circumscribing a predetermined space to treat the pet, and incorporating all necessary facilities with an aesthetical appearance.

### SUMMARY OF THE PRESENT INVENTION

A primary object of the present invention is to provide a pet cabinet defining a dressing area to circumscribe a predetermined range to the pet, so that a user is able to treat the pet without a hassle.

Another object of the present invention is to provide a pet cabinet, wherein all pet accessories and feeding wares could be hidden within the cabinet, when the dressing area is defined, the pet accessories and feeding wares could be automatically exposed to the user for a convenient access.

Another object of the present invention is to provide a pet cabinet, which comprises a bottom housing for accommodating the pet, wherein an easily accessible entrance for the pet is provided to access the bottom housing, a top side of such bottom housing could be employed as a dressing platform.

Another object of the present invention is to provide a pet cabinet having an easily-accessible compartment for storing some unwashed or unclean pet stuffs, such as leashes.

Another object of the present invention is to provide a pet cabinet, wherein no complicated structures or expensive materials are required to achieve the above mentioned objects.

Another object of the present invention is to provide a pet cabinet which is easily access to the user to clean for maintaining a better environment to the pet.

Another object of the present invention is to provide a pet cabinet which could be prepared with various designs and colors so that such cabinet may resemble household furniture.

Accordingly, to achieve above mentioned objects, the present invention provides a cabinet for a pet, comprising:

a cabinet body having an accessory compartment and a front opening communicating with the accessory compartment, wherein the dressing cabinet further comprises two fencing doors pivotally mounted at the front opening to fold between a storage position and a dressing position;

a dressing platform horizontally and frontwardly extended from the dressing cabinet at a position below the front opening for substantially supporting the pet on the dressing platform; and

two fencing stoppers provided at two sides of the front opening of the cabinet body respectively to retain the fencing doors at the dressing position, wherein at the storage position, the two fencing doors are pivotally folded to enclose the accessory compartment, and at the dressing position, the fencing doors are pivotally and outwardly folded until the fencing doors are blocked at the fencing stoppers respectively to form a dressing area within the fencing doors and the dressing platform, such that the fencing doors form two side fences for blocking the pet on the dressing platform from being escaped.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a pet cabinet according to a preferred embodiment of the present invention.

FIG. 2 is a perspective view of the pet cabinet according to the above preferred embodiment of the present invention illustrating the fencing door is pivotally opened for defining the dressing area.

FIG. 3 is a perspective view of the pet cabinet according to a second preferred embodiment of the present invention.

FIG. 4 is a perspective view of the pet cabinet according to the above second preferred embodiment of the present invention showing the cabinet is in an unfolded position.

FIG. 5 is a perspective view of the pet cabinet according to a third preferred embodiment of the present invention illustrating the dressing platform is defined as extractable panel received within the cabinet body.

### DETAILED DESCRIPTION OF THE PREFERRED EMBODIMENT

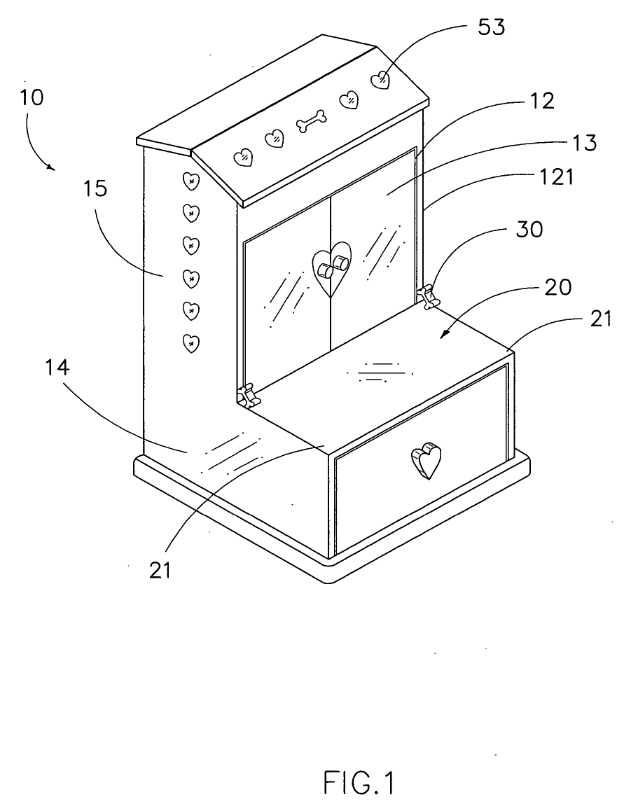

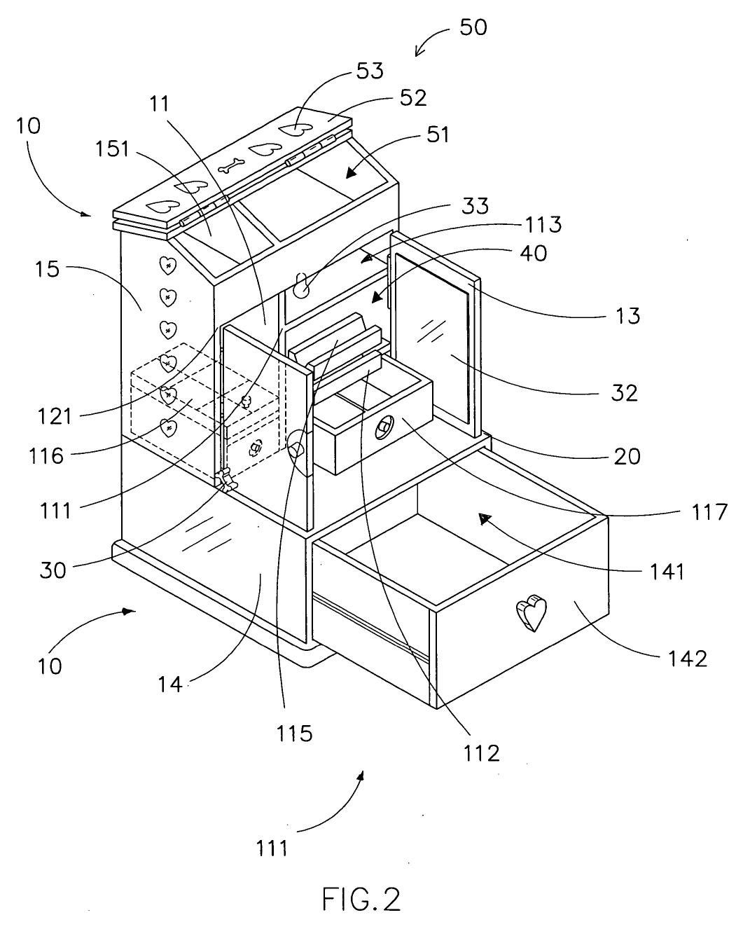

Referring to FIG. 1 and FIG. 2, the dressing cabinet 1 for a pet according to a first preferred embodiment of the present invention is illustrated. The dressing cabinet 1 comprises a cabinet body 10 having an accessory compartment 11 and a front opening 12 communicating with the accessory compartment 11, wherein the cabinet 1 further comprises two fencing doors 13 pivotally mounted at the front opening 12 to fold between a storage position and a dressing position.

Furthermore, the dressing cabinet 1 comprises a dressing platform 20 horizontally and frontwardly extended from the cabinet body 10 at a position below the front opening 12 for substantially supporting the pet on the dressing platform 20, and two fencing stoppers 30 provided at two sides of the front opening 12 of the cabinet body 10 respectively to retain the fencing doors 13 at the dressing position, wherein at the storage position, the two fencing doors 13 are pivotally folded to enclose the accessory compartment 11, and at the dressing position, the fencing doors 13 are pivotally and outwardly folded until the fencing doors 13 are blocked by the fencing stoppers 30 respectively to form a dressing area 40 within the fencing doors 13 and the dressing platform 20, such that the fencing doors 13 form two side fences for blocking the pet on the dressing platform 20 from being escaped.

According to the preferred embodiment, the dressing cabinet 1 is adapted to store and display a plurality of pet accessories within the accessory compartment 11, such as clothes, shoes, food wares, identity collars, leashes, body treating stuffs, and so on. On the other hand, the dressing cabinet 1 is embodied to accommodate the pet under certain circumstances. As shown in FIG. 1, the cabinet body 10 has a base portion 14 and a top displaying portion 15 integrally and uprightly extended from the base portion 14 wherein the accessory compartment 11 is defined within the top displaying portion 15.

Here, the top display portion 15 is uprightly extended from a rear top wall of the base portion 14 to form an L-shaped structure. Therefore, the front top wall of the base portion 14 is automatically exposed to form the dressing platform 20.

In other words, the base portion 14 and top display portion 15 are separated by a cross plate which is applied as a top wall of the base portion 14, and at the same time, as the bottom wall of the top display portion 15. The cross plate divides the cabinet body into a top portion 15 and a bottom portion 14. Preferably, the base portion 14 has an interior chamber 141 for receiving a storage drawer 142.

In the first preferred embodiment, the front side of the base portion of the cabinet body 10 is arranged to have an opening for exposing the interior chamber 141, wherein a storage drawer 142 is slidably and reciprocally inserted into the interior chamber 141 as shown in FIG. 2. That is to say, the storage drawer 142 is slidably engaged to the cabinet body 10, wherein the storage drawer 142 is adapted to be insertable within the interior chamber 141 for enclosing the storage drawer 142 or be extractable to expose the interior of the storage drawer 142. Commonly, the big sized pet accessories, such as bath towel, winter clothes, even foldable pet enclosure could be disposed within the storage drawer 142.

Here, it is worth to mention that the two fencing stoppers 30 are frontwardly extended from two side edges 121 of the front opening 12 respectively to retain the two fencing doors 13 at the dressing position. As shown in FIG. 1 and FIG. 2, the two fencing doors 13 are pivotally mounted to the two side edges 121 of the top displaying portion of the cabinet body 10, wherein the fencing stoppers 30 are further extended from the cabinet body 10 for preventing the foldable fencing doors 13 from further pivotal movement with respect to the front opening 12.

The top displaying portion 15 of the cabinet body 10 is vertically elongated shaped, having two lateral panels integrally and uprightly extended from the top end of the base portion 14, a back wall interconnected the lateral panels, and a roof panel 151 spanning across the later panels and the back wall to form the accessory compartment 11 there between. Accordingly, each of the fencing doors 13 is respectively and pivotally mounted to the two lateral panels, such that when the two fencing doors 13 are pivotally and outwardly folded, the dressing area 40 is defined between the two fencing doors 13 and the dressing platform 20 as shown in FIG. 1 and FIG. 2.

That is to say, the dressing platform 20 has a pair of opposite edges 21 defined at two lateral sides of the cabinet body 10 to be longitudinally aligned with the fencing stopper 30 for limiting off the dressing area 40 within a predetermined size. It is noted that a mirror 32 could be attached onto the inner side of the fencing door 13, so that when a pet is disposed at the dressing area 40, a better angle image of the pet could be viewed by the user. Furthermore, there is an illuminator 33 disposed within the accessory compartment 11 for lightening up the dressing area 40.

According to the present invention, the dressing cabinet 1 further comprises an attic frame 50 formed on top of the cabinet body 10, wherein the attic frame 50 has a top compartment 51 and a ceiling panel 52 pivotally mounted on the cabinet body 10 for enclosing the top compartment 51. Here, the attic frame 50 is nested onto the roof panel 151 of the top displaying portion 15 of the cabinet body 10 for storing a plurality of easily-accessible pet stuffs, such as pet leashes and pet collars. It is noted that the attic frame 50 further comprises a plurality of decorative windows 53 spacedly formed on the ceiling panel 52 for allowing the top compartment 51 to be seen from an exterior of the attic frame 50. In other words, the ceiling panel 52 is defined as a perforated panel not only for decorative purposes, but also for ergonomic and convenient services to the users.

The cabinet body 10 further comprises a closet frame 111 provided within the accessory compartment 11, wherein the closet frame 111 comprises a clothes hanger 112 for hanging pet clothing, a closet shelving 113 for storing pet accessories, and a shoe rack 115 for holding pet shoes. That is to say, the accessory compartment 11 could be arranged to have a plurality of interior chambers for storing different pet-related stuffs, wherein the plurality of the interior chambers shares the front opening 12. As a result, once the two fencing doors 13 are outwardly folded, the pet-related stuffs could be viewed as well as accessed by the users.

Preferably, the closet frame 111 enables the accessory compartment 11 storing pet accessories in a separated manner. As shown in FIG. 2, the accessory compartment 11 is divided into a left compartment and a right compartment, wherein a plurality of transverse plates are spacedly provided at the right compartment for sub-dividing the right compartment into a row of sub-compartments. As shown in FIG. 2, the bottommost portion of the left compartment is applied to receive a pet jewelry box 116 for storing pet jewelries. Preferably, the pet jewelry box 116 is grid shaped having 6-9 well chambers. Therefore, a user is able to conveniently sort out a variety of jewelries within the pet jewelry box 116. It is noted that the clothes hanger 112 is disposed within an upper portion of the left compartment. The right compartment could be applied for storing pet combs, medical care products, etc. One of the sub-compartments could be defined to install the rotatable pet shoe rack 115. On the other hand, the lateral panels of the top portion 15 are defined as a perforated panel having a row of see-through glass window on it, so that the well organized pet jewelries stored within the pet jewelry box 116 could be easily viewed from an outside.

Regarding to user's preference, the accessory compartment 11 could be reorganized for mainly storing pet-related food wares and food. The cabinet body 10 further has a food compartment 117 for storing dry pet food and can food in a separated manner. Accordingly, the left side of the food compartment 117 of the present invention is designed to store at least 12-16 cans of pet food. The bottom drawer disposed within the left compartment could be redesigned to contain food wares. Accordingly, the right side of the food compartment 117 could be applied to store dry pet food such as biscuit and treat respectively. Accordingly, the partition wall of the food compartment 117 for separating the dry pet food and the can food can be selectively adjusted to adjust a partition space of the food compartment 117 to store the can food and/or the dry pet food.

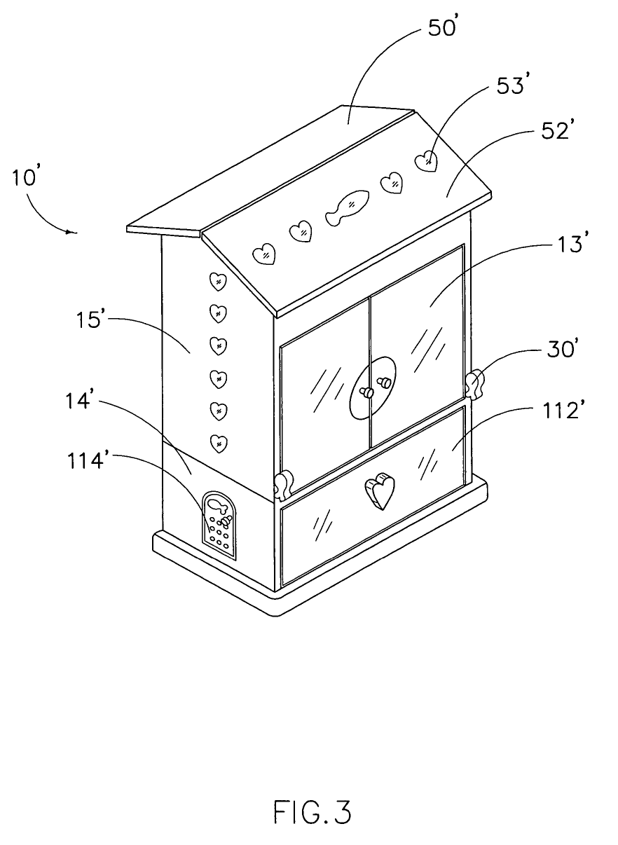

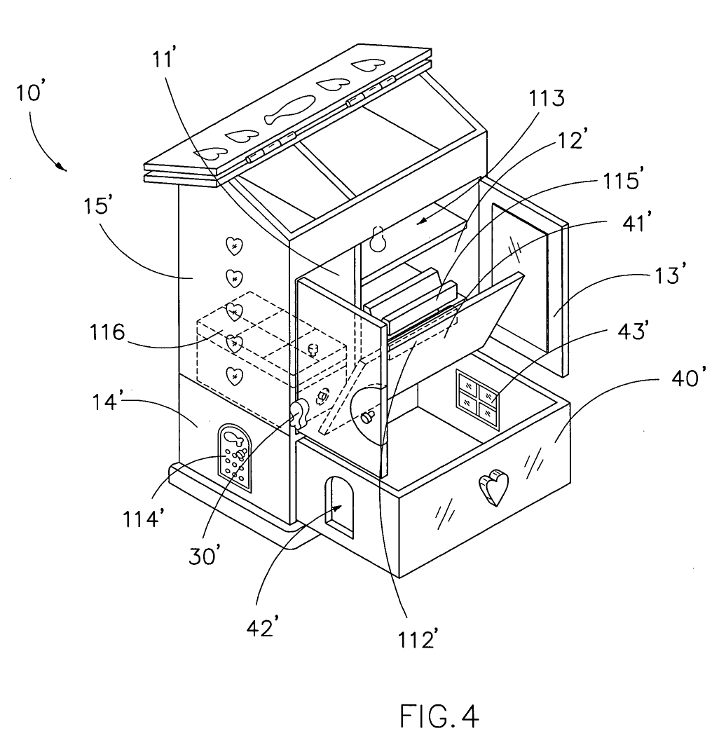

Referring to FIG. 3 to FIG. 4, the pet cabinet 1′ according to a second preferred embodiment is illustrated. Compared with the pet cabinet 1 of the first preferred embodiment, the pet cabinet 1′ of the second preferred embodiment has a similar structure. Here, the pet cabinet 1′ comprises a cabinet body 10′ having an accessory compartment 11′ and a front opening 12′ communicating with the accessory compartment 11′, wherein the pet cabinet 1′ further comprises two fencing doors 13′ pivotally mounted at the front opening 12′ to fold between a storage position and a dressing position.

The difference is that the top displaying portion 15′ of the cabinet body 10′ is alignedly and integrally extended from the base portion 14′ of the cabinet body 10′. That is to say, the cabinet body 10′ is integrally embodied as a vertical elongated shaped cabinet, wherein base portion 14′ of the cabinet body 10′ has an interior chamber 141′ therein and a bottom pet housing 40′ is extractably received within the interior chamber 141′ in such a manner that when the bottom pet housing 40′ is extracted out from the interior chamber 141′, a top ceiling 41′ of the bottom pet housing 40′ is formed as a dressing platform 20′ for placing the pet thereon. Accordingly, the pet cabinet 1′ comprises a pair of fencing doors 30′ pivotally mounted to the cabinet body 12′ for circumscribing a dressing area 40′.

In other words, in the second preferred embodiment of the present invention, the dressing cabinet 1 further comprises a bottom pet housing 40′, having a side entrance 42′, slidably mounted to the cabinet body 10′ at a position below the front opening 12′ for accommodating the pet in the bottom pet housing 40′, wherein the bottom pet housing 40 is selectively slid out from the cabinet body 10 to form the dressing platform 20 at the top ceiling 41′ of the pet housing 40′ for the pet sitting thereon.

Here, the extractable bottom pet housing 40′ is applied as a drawer-style enclosure with a side entrance 42′ allowing access to a pet. Accordingly, there is a side door 114′ provided at a lateral wall of the cabinet body 10′ for correspondingly aligning with the side entrance 42′ when the bottom pet housing 40′ is received within the interior chamber 141′. Moreover, the extractable bottom pet housing 40′ comprises a top ceiling 41′ having a fixed portion and a foldable portion hinged with the fixed portion, so that when the bottom pet housing 40′ is extracted from the interior chamber 141′, the foldable portion of the top cover 42′ is upwardly folded to expose the interior chamber 141′ to outside.

It is noted that the cabinet body 10′ includes at least a screened or perforated side wall for an easy see-through function. Particularly, the bottom pet housing 40′ further comprises a side see-through window 43′ provided at another side wall opposite with the side entrance 41′. As a result, a user is able to check whether the pet is rested within the bottom pet housing 40′ via the screened side wall and the see-through window 43′. To clean the bottom pet housing 40′, the extractable pet housing 112′ is slide out and the top cover 42′ is opened for cleaning action.

Accordingly, the cabinet body 10′ of the second preferred embodiment also comprises a closet frame 111′ provided within the accessory compartment 11′, wherein the closet frame 111′ comprises a clothes hanger 112′ for hanging pet clothing, a closet shelving 113′ for storing pet accessories, and a shoe rack 115′ for holding pet shoes.

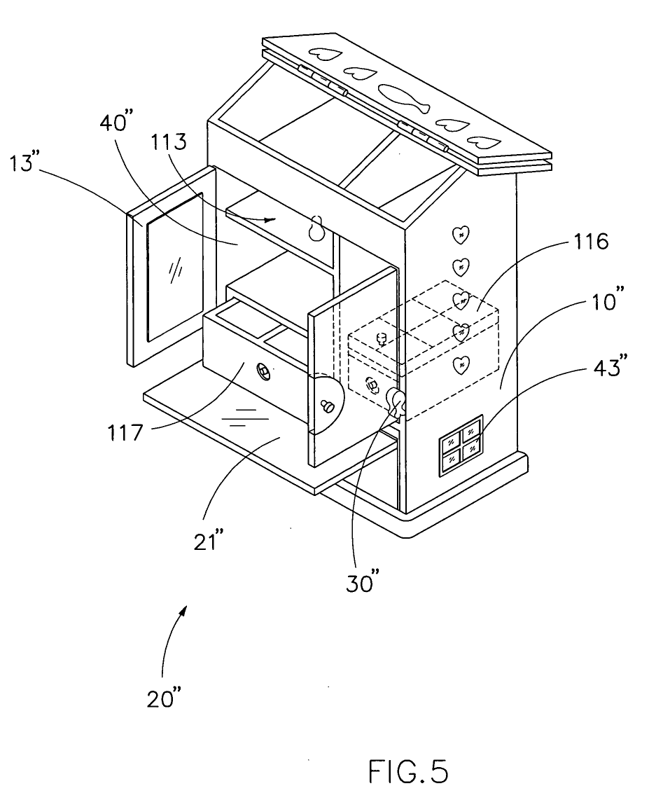

Or otherwise, as shown in FIG. 5, a third preferred embodiment of the present invention is illustrated. The dressing platform 20″ is defined as a sliding panel 21″ slidably inserted into the cabinet body 10″. Accordingly, there is a receiving cavity provided between a bottom side of the top displaying portion and the base portion, wherein the dressing platform 20″ is inserted into the receiving cavity. Once the user wish to treat the pet, he or she could easily pull out the dressing platform 20″, and then outwardly fold the fencing doors 13″ respectively and pivotally mounted to the side edges of the cabinet body 10″ to circumscribing a dressing area 40″ in a stable manner. It is worth to mention that the base portion of the cabinet body 10″ could be arranged to receive a storage drawer as shown in FIG. 2, or arranged to accommodate a bottom pet housing as shown in FIG. 4. Accordingly, there is a side see-through window 43″ is defined at a side wall of the cabinet body 10″ for a convenient checking purpose.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A cabinet for a pet, comprising:
a dressing cabinet comprising a cabinet body having an accessory compartment and a front opening communicating with said accessory compartment, wherein said dressing cabinet further comprises two fencing doors pivotally mounted at said front opening to fold between a storage position and a dressing position;
a dressing platform horizontally and frontwardly extended from said dressing cabinet at a position below said front opening for substantially supporting said pet on said dressing platform; and
two fencing stoppers provided at two sides of said front opening of said cabinet body respectively to retain said fencing doors at said dressing position, wherein at said storage position, said two fencing doors are pivotally folded to enclose said accessory compartment, and at said dressing position, said fencing doors are pivotally and outwardly folded until said fencing doors are blocked at said fencing stoppers respectively to form a dressing area within said fencing doors and said dressing platform, such that said fencing doors form two side fences for blocking said pet on said dressing platform from being escaped.

2. The cabinet, as recited in claim 1, wherein said two fencing stoppers are frontwardly extended from two side edges of said front opening respectively to retain said two fencing doors at said dressing position.

3. The cabinet, as recited in claim 1, wherein said dressing cabinet further comprises an attic frame, which is formed on top of said cabinet body, having a top compartment and comprising a ceiling panel pivotally mounted on top of said cabinet body to enclose said top compartment.

4. The cabinet, as recited in claim 2, wherein said dressing cabinet further comprises an attic frame, which is formed on top of said cabinet body, having a top compartment and comprising a ceiling panel pivotally mounted on top of said cabinet body to enclose said top compartment.

5. The cabinet, as recited in claim 3, wherein said attic frame further has a plurality of decorative windows spacedly formed on said ceiling panel for allowing said top compartment from being seen from an exterior of said attic frame.

6. The cabinet, as recited in claim 4, wherein said attic frame further has a plurality of decorative windows spacedly formed on said ceiling panel for allowing said top compartment from being seen from an exterior of said attic frame.

7. The cabinet, as recited in claim 1, wherein said dressing cabinet further comprises a bottom storage drawer formed below said front opening of said cabinet body, wherein said dressing platform is formed on a ceiling of said storage drawer for said pet sitting thereon.

8. The cabinet, as recited in claim 2, wherein said dressing cabinet further comprises a bottom storage drawer formed below said front opening of said cabinet body, wherein said dressing platform is formed on a ceiling of said storage drawer for said pet sitting thereon.

9. The cabinet, as recited in claim 6, wherein said dressing cabinet further comprises a bottom storage drawer formed below said front opening of said cabinet body, wherein said dressing platform is formed on a ceiling of said storage drawer for said pet sitting thereon.

10. The cabinet, as recited in claim 1, wherein said dressing cabinet further comprises a bottom pet housing, having a side entrance, slidably mounted to said cabinet body at a position below said front opening for accommodating said pet in said pet housing, wherein said pet housing is selectively slid out from said cabinet body to form said dressing platform at a ceiling of said pet housing for said pet sitting thereon.

11. The cabinet, as recited in claim 2, wherein said dressing cabinet further comprises a bottom pet housing, having a side entrance, slidably mounted to said cabinet body at a position below said front opening for accommodating said pet in said pet housing, wherein said pet housing is selectively slid out from said cabinet body to form aid dressing platform at a ceiling of said pet housing for said pet sitting thereon.

12. The cabinet, as recited in claim 6, wherein said dressing cabinet further comprises a bottom pet housing, having a side entrance, slidably mounted to said cabinet body at a position below said front opening for accommodating said pet in said pet housing, wherein said pet housing is selectively slid out from said cabinet body to form said dressing platform at a ceiling of said pet housing for said pet sitting thereon.

13. The cabinet, as recited in claim 1, wherein said dressing platform is slidably mounted to said cabinet body such that said dressing platform is adapted to selectively slide into said cabinet body in a hidden manner and slide out from said cabinet body for said pet sitting thereon.

14. The cabinet, as recited in claim 2, wherein said dressing platform is slidably mounted to said cabinet body such that said dressing platform is adapted to selectively slide into said cabinet body in a hidden manner and slide out from said cabinet body for said pet sitting thereon.

15. The cabinet, as recited in claim 6, wherein said dressing platform is slidably mounted to said cabinet body such that said dressing platform is adapted to selectively slide into said cabinet body in a hidden manner and slide out from said cabinet body for said pet sitting thereon.

16. The cabinet, as recited in claim 9, wherein said cabinet body further comprises a closet frame, which is provided within said accessory compartment, comprising a clothes hanger for hanging pet clothing, a closet shelving for storing pet accessories, a shoe rack for holding pet shoes, and a pet jewelry box for storing pet jewelries, wherein said cabinet body further has a food compartment for storing dry pet food and can food in a separated manner.

17. The cabinet, as recited in claim 12, wherein said cabinet body further comprises a closet frame, which is provided within said accessory compartment, comprising a clothes hanger for hanging pet clothing, a closet shelving for storing pet accessories, a shoe rack for holding pet shoes, and a pet jewelry box for storing pet jewelries, wherein said cabinet body further has a food compartment for storing dry pet food and can food in a separated manner.

18. The cabinet, as recited in claim 15, wherein said cabinet body further comprises a closet frame, which is provided within said accessory compartment, comprising a clothes hanger for hanging pet clothing, a closet shelving for storing pet accessories, a shoe rack for holding pet shoes, and a pet jewelry box for storing pet jewelries, wherein said cabinet body further has a food compartment for storing dry pet food and can food in a separated manner.

19. The cabinet, as recited in claim 16, further comprising a lighting arrangement provided in said accessory compartment for illumination.

20. The cabinet, as recited in claim 17, further comprising a lighting arrangement provided in said accessory compartment for illumination.

21. The cabinet, as recited in claim 18, further comprising a lighting arrangement provided in said accessory compartment for illumination.
